(19) United States
(12) Patent Application Publication
(10) Pub. No.: US 2014/0162790 A1
(43) Pub. Date: Jun. 12, 2014

(54) METHOD AND SYSTEM FOR FANTASY RECRUITING GAME

(71) Applicant: Bucknuts, LLC, Dayton, OH (US)

(72) Inventors: Leland Edward Schear, Dayton, OH (US); Daniel Aaron Rubin, Dayton, OH (US)

(21) Appl. No.: 14/092,198

(22) Filed: Nov. 27, 2013

Related U.S. Application Data
(60) Provisional application No. 61/734,475, filed on Dec. 7, 2012.

(51) Int. Cl. A63F 13/30

(52) U.S. Cl. CPC A63F 13/12
USPC 463/42

(57) ABSTRACT

A recruiting game having a unique point system that awards and deducts points based on a user or participant's selection of recruits who may play or even be awarded a scholarship at the user or participant's selected college or university.

### CROSS-REFERENCE TO RELATED APPLICATION

The present application claims priority to provisional U.S. Application Ser. No. 61/734,475 filed Dec. 7, 2012, to which Applicant claims the benefit of the earlier filing date. This provisional application is incorporated herein by reference and made a part hereof.

### BACKGROUND OF THE INVENTION

1. Field of the Invention

This disclosure relates to a fantasy recruiting game that lets users or participants compete against one another as they try to pick the upcoming recruiting class for a college or university team of their choice.

2. Description of the Related Art

Professional or college sports support a broad range of secondary competitions ranging from betting on the outcome of particular games to betting on a particular performance of a given recruit. Contests based upon recruits' performances include fantasy sports leagues, such as a fantasy baseball and fantasy football.

Other types of secondary competitions relating to professional or college sports teams are also provided. For example, the drafting of recruits into the fantasy sports leagues, wherein prior to the beginning of a professional sport season, a fantasy owner conducts a fantasy “draft” of professional athletes to fill the roster of their team. Imaginary teams are created and they usually employ the actual recruit positions in the sport, with spots on the rosters filled with recruits that play that particular position.

Collegiate or university sports, particularly football, have seen a dramatic increase in interest. The fans of the collegiate or university teams are oftentimes very loyal and active in following their team's performance during the season as well as off-season. During the season and off-season, college football teams, many of which are members of the National Collegiate Athletic Association (NCAA), are active in recruiting recruits, such as high school football or basketball players or recruits who are eligible to play on a collegiate or university level. It is not uncommon that multiple teams may vie for one recruit, particularly if the recruit is an outstanding high school athlete.

“Signing day” is a day usually in February of each year that players sign national letters of intent. The national letters of intent identify the recruit's choice of college or university by signing a letter of intent, a prospective student-athlete agrees to attend the designated college or university for one academic year in exchange for financial aid. Normally, a recruit's pick of the team he will play for is kept confidential until signing day unless the recruit elects to disclose it. On signing day, the recruits sign a letter of intent indicating the college or university for whom they will play.

A need exists for a sports contest which provides interactive competition among a plurality of participants and that relates to recruiting, particularly recruiting recruits for a college or university team. What is also needed is a recruiting competition that utilizes actual college or university teams, rather than fantasy teams, and actual recruits.

### SUMMARY OF THE INVENTION

One object of an embodiment of the invention is to provide a system and method for providing an interactive recruiting competition among a plurality of remote participants.

Another object of an embodiment of the invention is to provide a recruiting game that utilizes actual information about actual recruits and colleges or universities.

Another object of an embodiment of the invention is to provide a recruiting scoring system and method that awards points and assesses penalties based on the accuracy of the recruiting picks.

Still another object of an embodiment of the invention is to provide a recruiting system and method competition that awards points and assesses penalties based upon how early a recruit's selection of a college or university is made.

Still another object of an embodiment of the invention is to provide a system and method that gauges public sentiment on recruiting predictions.

Yet another object of an embodiment of the invention is to provide an interactive competitive recruiting game that challenges users to not only identify recruits that will be recruited, but also predict which ones will accept scholarships at a particular college or university.

Still another object of an embodiment of the invention is to provide a system and method that allows participants to compete in small leagues or divisions against themselves or against a national pool of fans of a particular college or university.

Some advantages and objects of the inventions disclosed herein include, but are not limited to, providing a system and process that provides:
An online, skill-based, multi-user or participant game that challenges users or participants to correctly identify high school football recruits and predict which ones will accept football scholarships at specific colleges or universities.
An online game that challenges users to predict the number of football scholarships a particular college or university will award in a given year.
A recruiting game that lets users set up “watchlists” to pull in the latest news and information on sought-after high school football recruits with all work being done through the established network database, such as 247Sports. Watch lists allow users to follow specific recruits they are targeting and considering adding to their team. By including a recruit on a watch list, the user can quickly view all the latest news and information on a recruit.
An online recruiting game that lets users or participants compete in small “leagues” against their family and friends, or in “divisions”, or in a broader pool, such as against a national pool of fans of a particular college or university.
A sophisticated scoring system that awards points and accesses penalties based on accuracy of football recruiting picks based on how early the prediction is made.
An interesting source of data on recruiting predictions. Extrapolations from recruit trends will allow the users or participants to make and publicize recruiting predictions based on opinions within the game.

In one aspect, one embodiment of the invention comprises an interactive recruiting game system for use by a plurality of participants, comprising software and a server having a controller and storage, a recruiting game resident on the server for enabling each of the plurality of participants to add at least one recruit who that participant forecasts will accept a scholarship to a predetermined college or university selected by the participant to that participant's recruit roster or list; and a database for storing data during use of the recruiting game, wherein the server generates a score for each of the plurality of participants based on each participant's forecasts and the actual decisions of the recruits.

In another aspect, another embodiment of the invention comprises a method of remotely interfacing with at least one player in a rule-based recruiting game over a communication medium operatively connected to one or more communication devices each being adapted to input and output data required by the rule-based recruiting game, the method comprising the steps of enabling at least one participant to use at least one of the one or more communication devises to add at least one recruit who the at least one participant forecasts will accept a scholarship to a predetermined college or university selected by the at least one participant to the at least one participant's recruit roster or list and generating a score for each of the at least one participant(s) by applying rules of the rule-based recruiting game based upon each of the at least one participant's forecasts and the actual decisions of the recruits.

In still another aspect, another embodiment of the invention comprises a method of playing a multiplayer recruit game which corresponds to an actual sporting event, the method comprising the steps of providing to each of a plurality of players, at least one web page for forecasting what recruits will accept a scholarship to a predetermined college or university selected by the participant and to adding the forecast recruits to that participant's recruit roster or list, receiving from each of the plurality of players, prior to a signing day, forecast decisions regarding the acceptance by one or more of the recruits of a scholarship to a the predetermined college or university, enabling the user to modify its forecast decisions during play of the recruiting game, obtaining at the conclusion of the recruiting game, information regarding actual selections by the recruits of their acceptance or non-acceptance of the scholarship to the predetermined college or university and generating a score for each of the plurality of players based upon a correlation between the forecast decision received from each player and the actual selections by each of the recruits.

These and other objects and advantages will be apparent from the following description, the accompanying drawings and the appended claims.

### BRIEF DESCRIPTION OF THE DRAWINGS

FIG. 1 is a schematic view of a recruiting system in accordance with one embodiment of the invention;

FIG. 2 is a schematic view illustrating the procedure or algorithm utilized by the recruiting system and method in accordance with one embodiment of the invention;

FIGS. 3A-3B are schematic diagrams showing an illustrative use of the recruiting system and method in accordance with one embodiment of the invention; and

FIGS. 4A-4F are additional schematic diagrams showing another illustrative view of two players competing against each other.

### DETAILED DESCRIPTION OF PREFERRED EMBODIMENTS

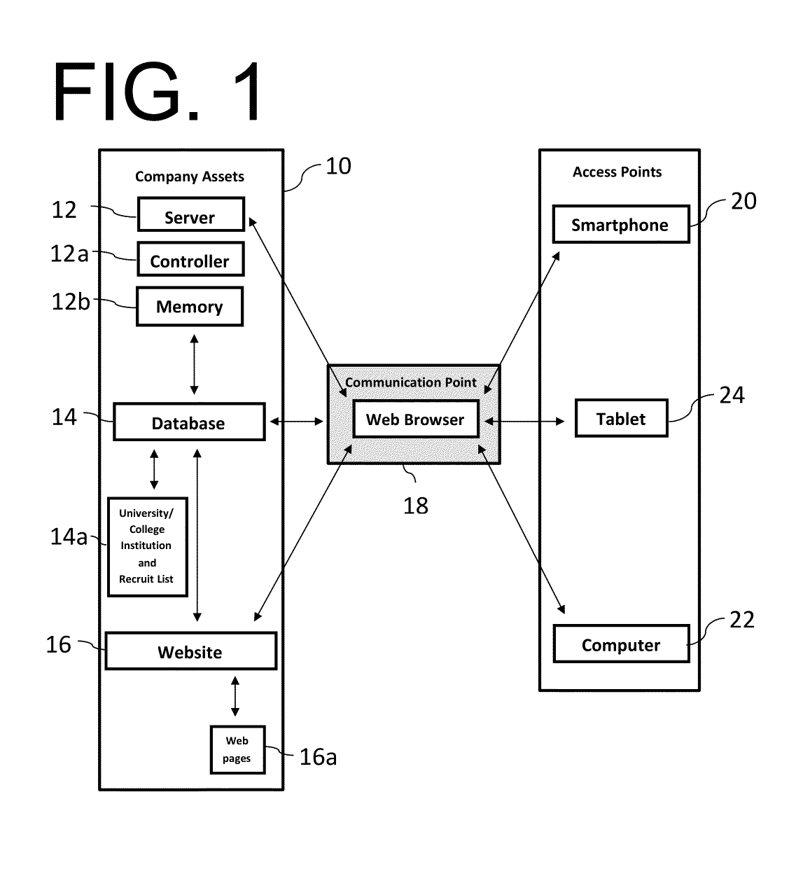

Referring now to FIG. 1, an interactive recruit game and method of playing a multi-user or participant recruit game system 10 is shown. The system 10 comprises a server 12, a database 14 and a website 16 containing web pages 16a, both of which are utilized by the server 12 to provide the recruit system 10, process and method. In the illustration being described, the server 12 is an Amazon Elastic Compute Cloud server with multiple locations in the Eastern United States. The database 14 is a MySQL® database running on Amazon's Elastic Block Store (EBS). The participants who play the recruiting game provided by the system 10 use a conventional web browser 18 described later. Participants may utilize a conventional smart phone 20, such as the Apple® iPhone® series of products, or the like or other Android® devices. The participant may also access the web browser utilizing a conventional computer 22 or a tablet 24, such as the Apple® iPad® or other tablet devices including the Microsoft® Surface, Google's Nexus and the Samsung Galaxy Tab.

In the illustration being described, the server 12 is a cloud server and incorporates a conventional controller or computer 12a and a memory storage device 12b, conventional hardwired or wireless modem (not shown) adapted to send and receive communications and data over a local area or wide-area network such as the internet (not shown) from one or more participants who are participating in the recruiting game and using the system 10.

The server 12 advantageously includes a lookup table (not shown) stored in database 14 and a program for calculating the points awarded or deducted as described later herein. At least one of the database 14 or memory storage device 12b comprises a listing of colleges or universities that may be selected by a participant and a recruit list 14a of the athletes or recruits that a participant associates or identifies as being a “recruit” of a particular college or university. The database 14 or memory storage device 12b also comprises the rules and web pages that make up the web site 16 and that are accessed and used by the participants when playing the recruiting game.

The database 14 or memory storage device 12b further comprises the website 16 mentioned having a plurality of web pages that may be accessed and displayed using the web browser 18. In the embodiment being described as mentioned earlier, the web browser 18 is a conventional web browser, such as the Internet Explorer product available from Microsoft Corporation of Redmond, Wash., the Safari® product from Apple Inc. of Cupertino, Calif. or other conventional web browsers such as the Firefox® browser from Mozilla Corporation of Mountain View, Calif. and the Chrome browser from Google, Inc. of Mountain View, Calif.

As mentioned previously herein, the server 12 operates a scripting language called PhP, which includes programming files that comprise the formulas and rules described later herein that are used to convert the participant's selection into a numerical performance value for each participant or player who is playing the recruiting game. In general, the server 12 calculates the numerical performance value for each participant on one or more predetermined days, such as national signing day which is generally in February of each year. The server 12 may modify a participant's score with point additions or deductions or penalties made over the course of a user or participant playing the game. In this regard, while the system 10 and method and game described herein are considered a fantasy recruiting game, much of the information may be based on actual information at the time, such as the names of the actual colleges or universities, names of actual recruits and the like.

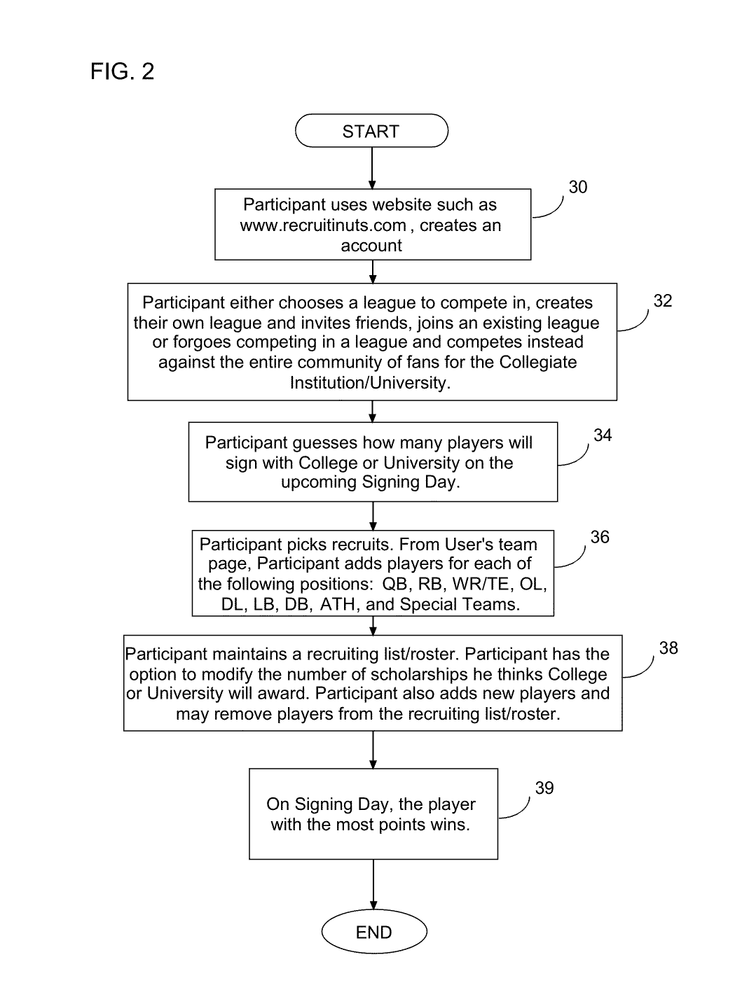

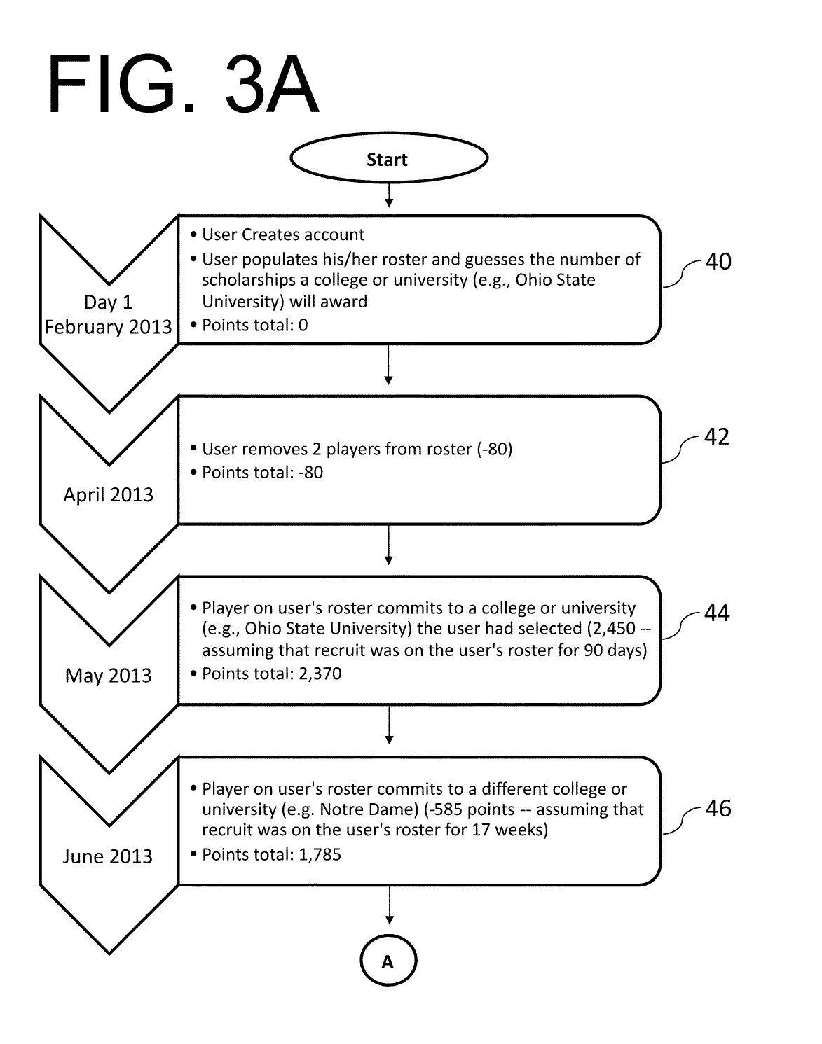

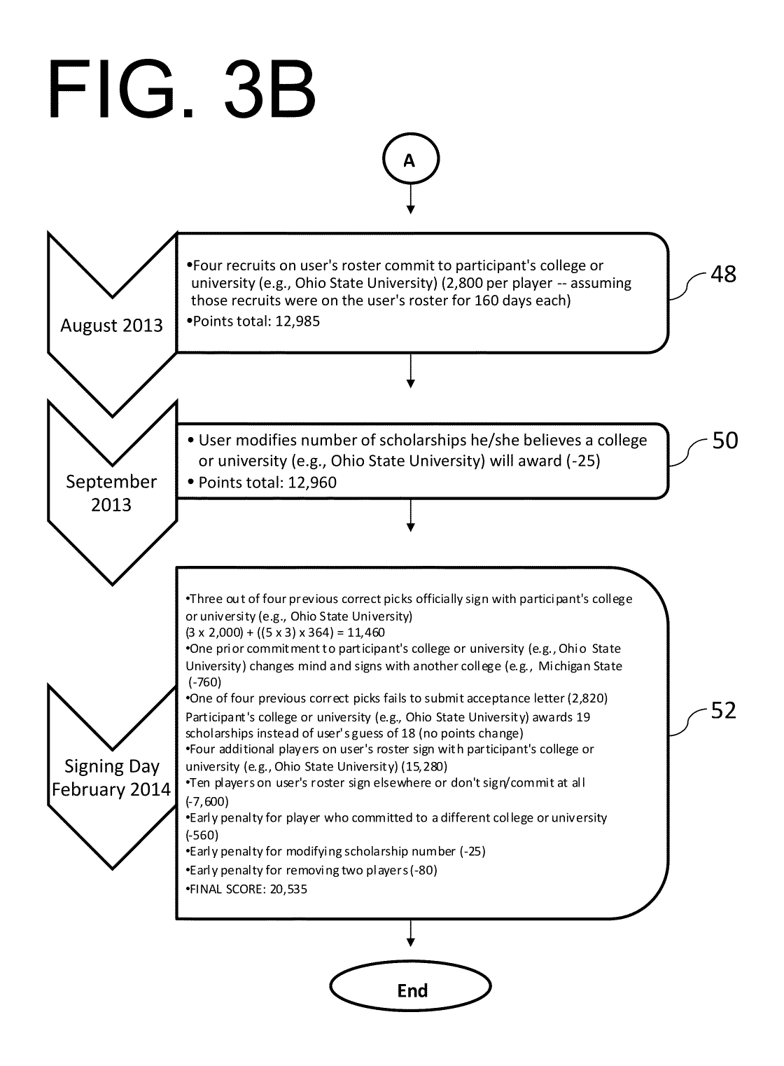

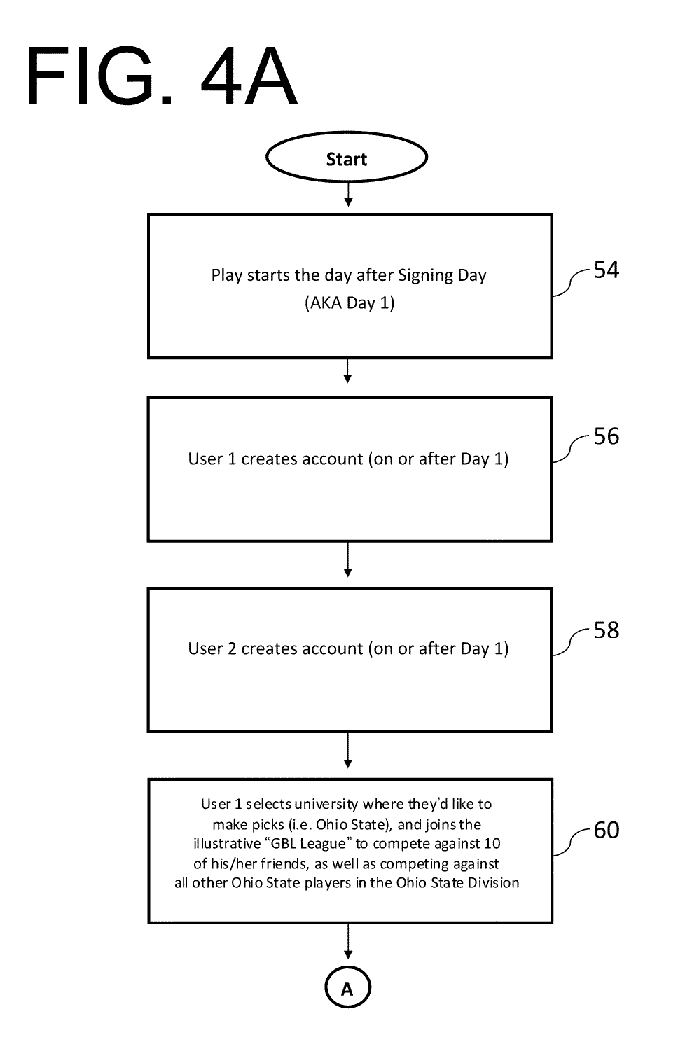

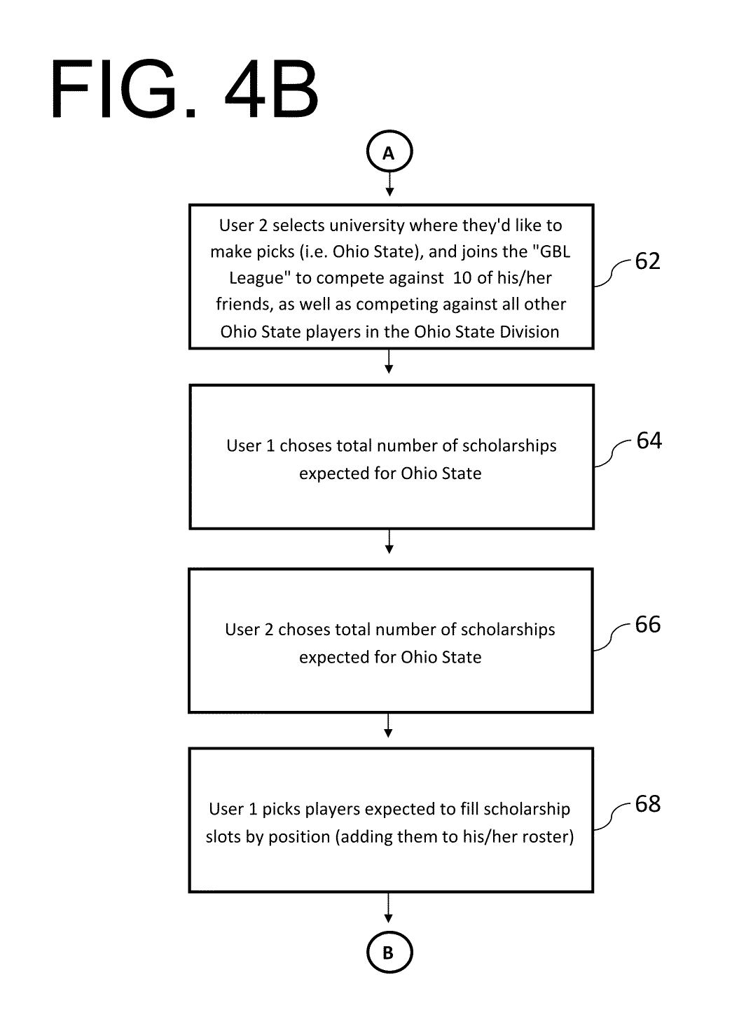

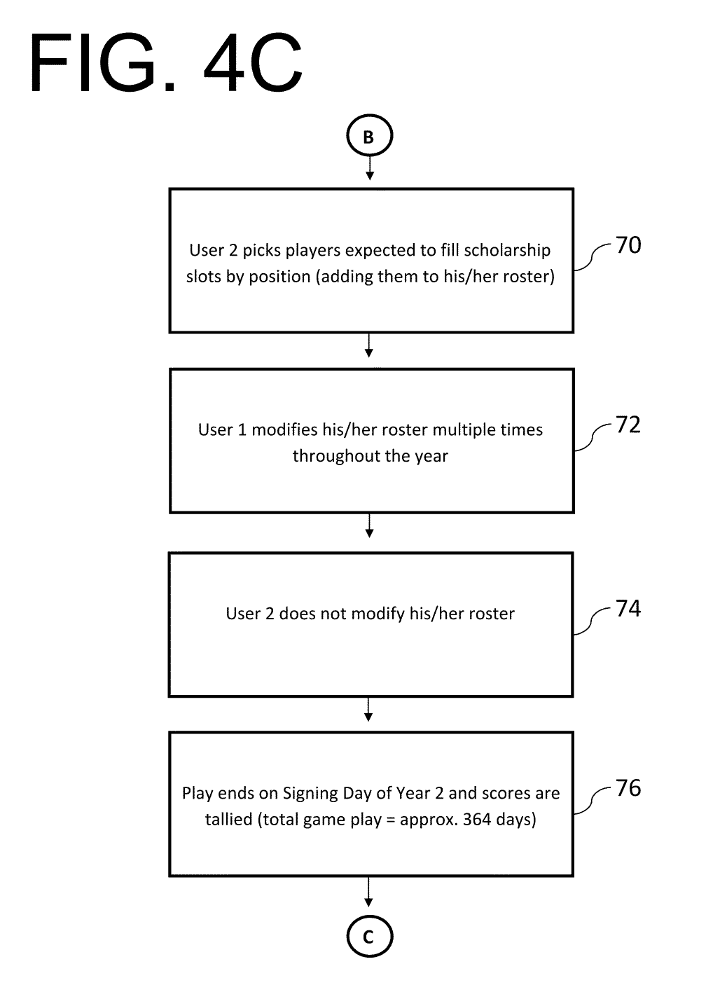

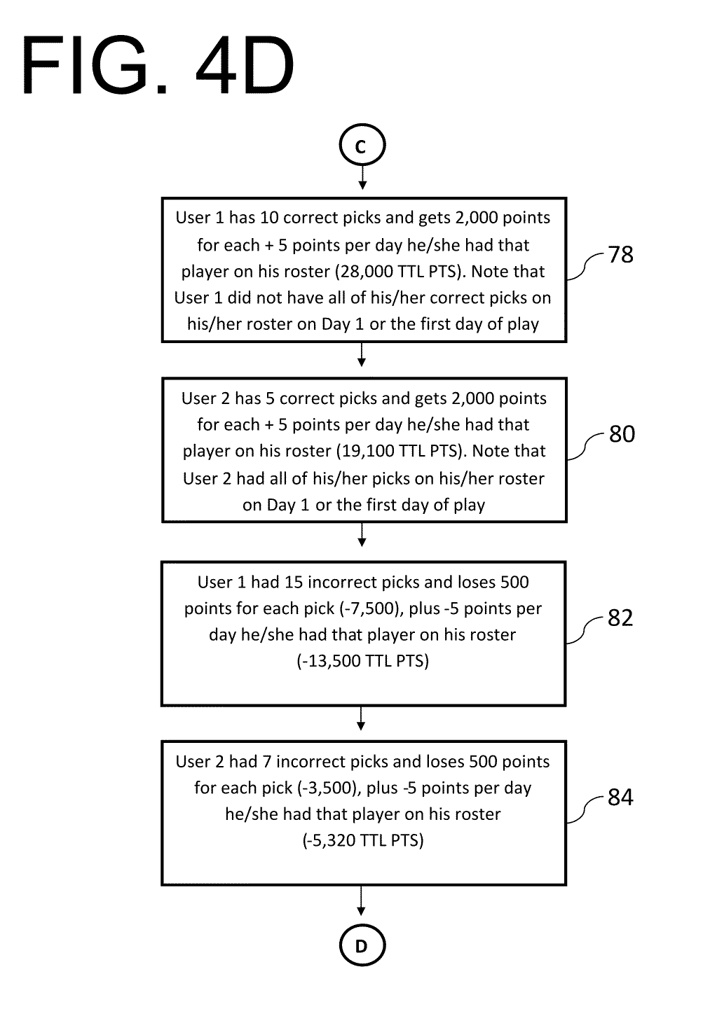

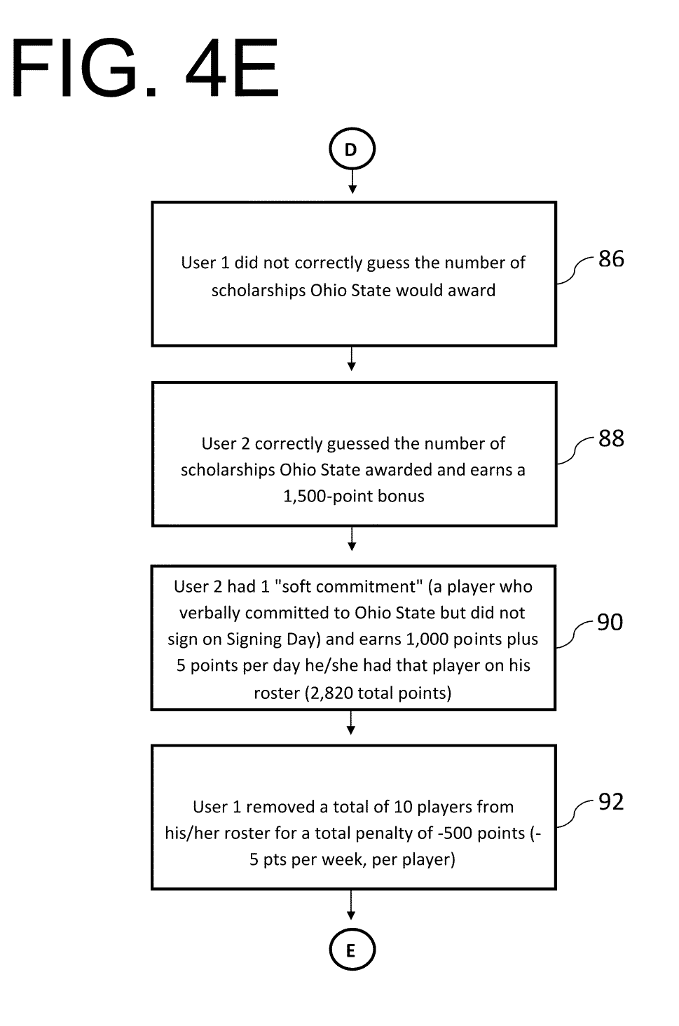

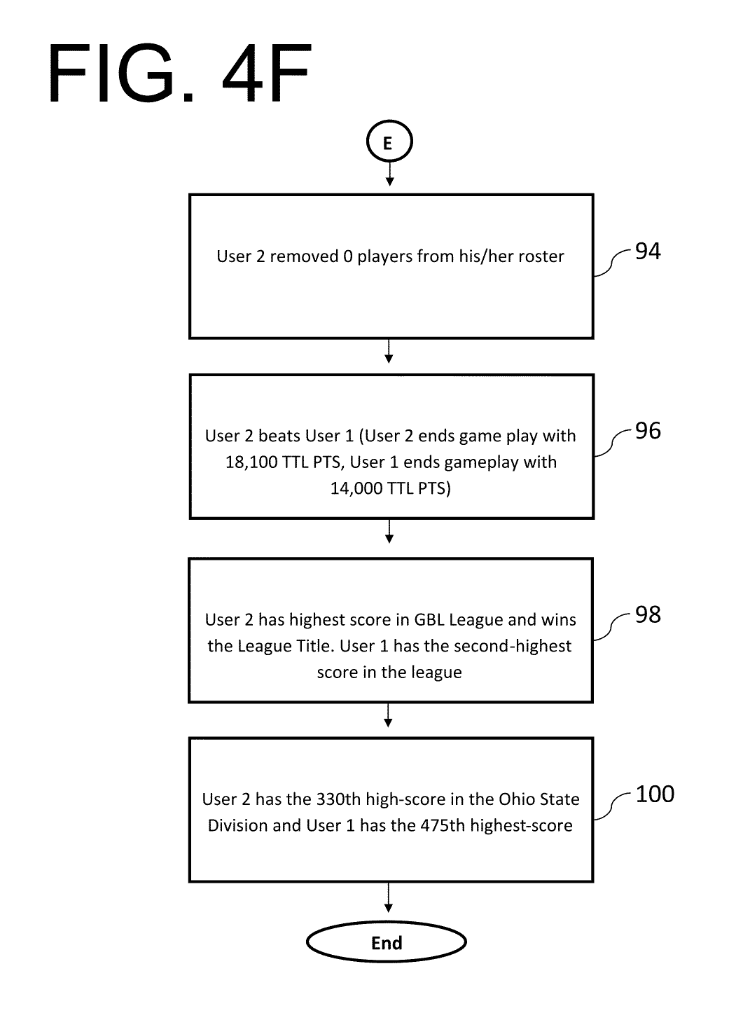

Referring now to FIG. 2, a schematic diagram of the process and procedure for playing the game will now be described. It should be understood that the algorithm, process and procedure described herein are performed by server 12 executing computer instructions that are stored in the memory storage device 12b (FIG. 1). They may also be provided in the form of a mobile application to the user or participant. The general procedure of how to play the recruiting game will now be described, with two specific illustrative examples being described later herein relative to FIGS. 3A-3B and 4A-4F. It should be understood that multiple participants may play and may begin playing at any point in a given playing season, such as any time before the next national signing day, which in one embodiment is the end of playing year.

In one embodiment, the game starts on the first day after national signing day, which is typically the first Wednesday in February of every year. The game concludes on the next year's signing day. Users or participants (i.e., players of the recruiting game) can join the game throughout the year, however, users or participants can be awarded bonus points the earlier in time they make a correct recruit pick. Thus, latecomers to the game may not be able to score as many points as their peers or other users or participants who joined the game earlier in the season. If a participant joins the game later in the year, the participant may elect to compete in a league created on the day the participant joined the game. One or more additional participants may join the same league on the same day. In this case, the maximum number of points each participant in the league can score is the same since they joined the league on the same day.

Referring now to FIG. 2, at block 30, the user or game participant signs up for an account by visiting the webpage 16 (FIG. 1) using the browser 18. One exemplary website 16 is located at www.recruitnuts.com. The participant picks the college or university he would like to compete with (for example, the participant may pick The Ohio State University®). The participant creates an account (block 30 in FIG. 2) and creates a custom user or participant name and password using a web page having a graphical user interface provided by the website 16. The various web pages 16a making up the website 16 are described later herein. In the illustration being described, the website 16 also requires the participant to link the participant's account with a desired email address for login purposes so that the website 16 may send the participant notifications during the playing of the game. Once the participant's account has been created and a college or university selected, the server 12 allocates the selected college or university team to that user or participant and then allocates a portion of the database 14 so that the user or participant can populate a recruit list with the participant's selected recruit picks for that participant's selected college or university.

It should be understood that in one embodiment, the user or participant may choose (block 32 in FIG. 2) a league, such as a Big Ten League®, a Pac Ten® League, a Southeastern Conference® League, an Atlantic Coast Conference® League or the like. In addition, the user or participant may create their own league and invite other participants, such as friends, to join that participant's league. The website 16 may also permit the user or participant to join an existing league or forego competing in a league altogether and compete against an entire community of fans for one or more selected colleges or universities.

In the illustration being described, the game proceeds and is adapted to provide the user or participant with opportunity to accumulate points based on a scoring system, which is summarized in Table I described later herein. As illustrated in FIG. 2, block 34, one opportunity for scoring points is for the user or participant to guess how many recruits will sign with the user or participant's selected college or university on the upcoming signing day (i.e., the next signing day). The points associated with a user or participant correctly picking how many recruits that will sign with that user or participant's selected college or university is described later herein.

The game proceeds to block 36 in FIG. 2 wherein the website 16 and server 12 provide the user or participant with web pages described later that enable the user or participant to play the game using the web browser 18. The user or participant may use the web pages 16a at website 16 to pick or assign recruits from a list of recruits from the database 14, or, alternatively, the user or participant may add or assign recruits to the user or participant's recruit list for that user or participant's selected college or university. In the embodiment being described, the process, game and system 10 are used as a recruiting game for college football in the illustration. Accordingly, the system 10 is adapted to provide the web pages 16a at the website 16 wherein the user or participant may enter, assign or pick from a database of recruit names stored in the database 14, a recruit for at least one or a plurality of football playing positions. In one embodiment, the positions comprise quarterback (QB), running back (RB), wide receiver (WR), tight end (TE), offensive lineman (OL), defensive lineman, (DL), linebacker (LB), defensive back (DB), athlete (ATH) and Special Teams (ST).

The game continues at block 38 in FIG. 2 wherein the user or participant creates or maintains his or her unique recruiting list or roster that is stored on the database 14 by the server 12 as the user or participant interacts through his or her web browser 18 with the website 16. The database provides a list of popular recruits from which the participant can select that recruit's name. The user or participant uses the website 16 to input his or her pick of one or more colleges or universities as well as one or more recruits who the user or participant believes will commit to that college or university. Throughout the playing of the game, which lasts between signing days, the user or participant has the option to modify the data associated with his or her recruit list for a college or university selected. For example, the user or participant may modify the number of scholarships he or she thinks the college or university will award. The user or participant can also add new recruits to his recruiting list or roster and may remove recruits from his or her recruit list or roster. The user or participant's selections of colleges and universities and recruit list are stored by server 12 in database 14.

As one or more users or participants play the recruiting game throughout the year, the software calculates a cumulative score based upon the user or participant's picks and activity and stores the score in either database 14 or memory storage device 12b (FIG. 1) as mentioned. As mentioned earlier herein, the sooner a user or participant adds a recruit who eventually commits to the college or university that the participant has selected, the user or participant accumulates more points, compared to a different or competing user or participant who selects the same recruit at a later date (i.e., closer to the upcoming or next signing day). In the illustration being described, the server 12 may also deduct points from a cumulative total of points that the user or participant has accumulated while playing, which will be described in more detail below. One such circumstance is when a participant removes a selected recruit from his or her recruiting list or roster, a point penalty is deducted from the participant's cumulative point total. The following Table I summarizes the points that may be accumulated or deducted. It should be understood that this information is provided to the user or participant at the website 16 which the user or participant can access using the browser 18 via the user or participant's smart phone 20, computer 22 or tablet 24. The data in Table I is stored in the database 14 and accessible by the user or participant, and in one illustrative embodiment, may be presented on a web page 16a (FIG. 1) that the user or participant can access through the website 16.

TABLE I
Scoring Chart
How Scoring Works

| Scoring Chart Action | Points |
|---|---|
| Correct Pick of a Recruit | Two-thousand points |
| Commitment Bonus | Five points per day the user or |
| | participant had that recruit on the |
| | recruiting list or roster for a maximum of |
| | one-thousand eight hundred and twenty |
| | points (364 × 5) |
| Recruits Removal Penalty | Minus five points per week the user or |
| | participant had that recruit on the |
| | recruiting list or roster (minimum of |
| | minus five, maximum of minus two |
| | hundred and sixty) |
| Scholarship Bonus (correctly | Fifteen hundred points |
| picking the number of | |
| scholarships a college or | |
| university awards) | |
| Incorrect Pick Penalty | Minus five hundred points (plus minus |
| | five points per week the user or |
| | participant had that recruit on the |
| | recruiting list or roster) |
| Soft Commitment Penalty | One-thousand points, plus five points |
| (reduced points for recruits | per day the user or participant had that |
| who verbally commit but do | recruit on the recruiting list or roster |
| NOT sign on signing day) | (One-thousand points will be awarded |
| | instead of the customary two-thousand |
| | points for a correct pick if a recruit has |
| | verbally with the college or university, |
| | but fails to officially sign on signing |
| | day). |
| Scholarship Penalty | Minus twenty five points (one edit is |
| (modifying the number of | allowed without any penalty in one |
| scholarships the user or | embodiment) |
| participant thinks the college | |
| or university will award | |

The scoring and scoring chart action summary in Table I will now be described.

CORRECT PICK AWARD POINTS: Scoring starts on day 1, which in one embodiment is the day after signing day for a current calendar year. Scoring ends on day 364, which is signing day for the next calendar year. Each correct fantasy recruiting pick is worth a predetermined correct pick award, such as two-thousand points. In order to collect those points, the participant must have a recruit on their recruiting list or roster at the time that recruit faxes, sends or communicates his or her signed National Letter of Intent to a college or university. The current procedure by which a recruit provides written notification of the college or university of where the athlete recruit intends to play his or her sport is by faxing his letter of intent into his selected college or university. Note that when a recruit verbally commits (as opposed to a formal commitment in writing) to a college or university prior to signing day, the user or participant will see an award of the commitment points made by the server 12, which is two-thousand points in the example, but those points will be provisional until the upcoming signing day. It should be noted that it is permissible to add a recruit to the participant's recruiting list or roster who has already verbally committed to the participant's selected college or university, the participant will receive the predetermined correct pick award, (e.g., two-thousand provisional points) for that pick, plus a predetermined commitment bonus award, such as five bonus points per day (as noted below in the commitment bonus points section).

COMMITMENT BONUS POINTS: The participant will receive the predetermined commitment bonus for every day the participant had a recruit on their recruiting list or roster before the recruit signs with the college or university. In one embodiment, the predetermined commitment bonus is five points. Thus, the most points the participant could get for any correct pick is the predetermined correct pick award plus the predetermined commitment bonus award. In the example, therefore, the award is three thousand eight hundred and twenty-five (two thousand points, plus one thousand eight hundred and twenty bonus points if the participant correctly picked a recruit on day 1 who verbals/signs with the college or university on day 364). All points are provisional until the end of signing day.

RECRUIT REMOVAL PENALTY: If the user or participant removes a previously-selected recruit from his recruiting list or roster (e.g., to substitute a different recruit), then the participant will receive a penalty or deduction of a predetermined recruit removal penalty. In one embodiment, the predetermined recruit penalty is five points for every week (seven calendar days or one hundred and sixty eight hours) that recruit was on the participant's recruiting list or roster with a minimum penalty of five points (even if the participant had a previously-selected recruit on their recruiting list or roster for just a few minutes). Notwithstanding the penalty, it may be wise in some instances to remove a selected recruit from the user or participant's recruit list in some circumstances. For example, if the participant has a previously-selected recruit on their recruiting list or roster who verbally commits to a different college or university, the participant will likely want to remove that recruit from their recruiting list or roster and replace him with another recruit they suspect will commit to a user or participant's college or university.

INCORRECT PICK PENALTY: If the user or participant has a recruit actively on their recruiting list or roster, and that recruit commits (including a verbal commitment) to a school other than the college or university they chose, the participant will be subject to a predetermined incorrect pick penalty, which in one embodiment is a five hundred point penalty. The participant will likely want to remove that recruit from their recruiting list or roster. However, if the participant is convinced that the recruit's verbal commitment is “soft” and that recruit will eventually commit to the college or university they have chosen, the participant can leave him/her on their recruiting list or roster. Should that recruit commit to the college or university, the participant's predetermined incorrect pick penalty, five hundred penalty points in the example, will be rescinded, and the participant will get those points back so the user or participant receives the total points mentioned earlier for making a correct pick. When the participant removes a recruit from their recruiting list or roster who committed to a college or university other than the college or university selected by the user or participant, the user or participant will be assessed the predetermined recruit removal penalty. In this example, this is the five point penalty for every week that recruit was on their recruiting list or roster in addition to the five hundred point penalty for an incorrect pick as mentioned earlier. Of course, the user or participant will not be awarded any points for that incorrect recruit pick.

SCHOLARSHIP BONUS: A big unknown in recruiting is the number of scholarships the college or university will award in a given year. When the user or participant first sets up his or her account, he or she will be given the option of guessing how many scholarships will be awarded that year. The user or participant can edit this number at any time during the play of the recruiting game. The user or participant can edit that number once without being subject to a penalty. Every time the user or participant edits their scholarship count after that, though, the user or participant will be subject to a predetermined scholarship penalty, such as a twenty-five point penalty. In one embodiment, the user or participant cannot change their scholarship count within the forty-eight hours before signing day. At the conclusion of the game, if the user or participant correctly identifies the number of recruits who sign with the college or university on signing day, they will earn predetermined scholarship bonus points, such as a bonus of fifteen hundred points in the example. If a recruit does not officially sign with the college or university on signing day, but they have verbally committed to the college or university, they will count toward the total number of awarded scholarships for the purposes of determining whether a user or participant should be awarded the predetermined scholarship bonus. Thus, verbal or “soft” commitments and hard commitments (i.e., those that have signed a national letter of intent) will count toward the total.

UNSIGNED PENALTY: If a recruit has verbally committed to the college or university, but does not submit his official national letter of acceptance on signing day, the participant will be awarded a reduced number of correct pick points, such as one half of the predetermined correct pick award, such as they would have gotten had that recruit officially signed with the college or university. In the example, the participant will get one thousand points for their correct pick (rather than the customary two thousand points), plus the predetermined commitment bonus award of five points per day the participant had that recruit on their recruiting list or roster in the example.

INDECISION: If a recruit does not officially sign on signing day but verbally commits, then that recruit's “verbal” commitment will be considered official, although the decision will still be subject to the soft commitment penalty. If the participant's recruiting list or roster features a recruit who does not make a decision on or by signing day or signs with a team other than the college or university, that recruit pick will be considered incorrect. This would negate the soft commitment penalty and the user would be subject to the incorrect pick penalty as described earlier herein.

WINNING THE GAME: The overall winner of the game is the participant with the most points at the conclusion of signing day (day 365 in the example). The winner of a league will also be the user or participant with the most points at the conclusion of signing day (day 365). Remember, verbal or “soft” commitments who do not officially sign but do commit will be considered correct but subject to a soft commitment penalty, and recruits who do not commit or make a decision on or by signing day will be considered incorrect.

KEY DATE WINNERS: At one or more preselected award days throughout the recruiting season, prizes for individual points leaders and participants with the highest possible points at that time will be awarded. These “key dates” may be predetermined and set each year and announced on the website 16.

Referring now to FIGS. 3A-3B, an illustrative example of step-by-step instruction on the game's scoring process and method will now be described. For ease of understanding and to illustrate the game's process and system, a hypothetical user or participant is followed through an entire season of the fantasy recruiting game. An illustration with multiple players is described later herein relative to FIGS. 4A-4F. As mentioned earlier herein, a “season” begins on the day after a signing day and ends on the subsequent signing day one year later. As also mentioned earlier, the server 12 tracks the recruit's playing of the game and maintains a cumulative point total of the accumulated points for all the users or participants utilizing the point system described earlier herein.

Referring now to FIGS. 3A-3B, the user or participant creates the account as mentioned earlier herein relative to block 30 in FIG. 2, at block 40 in FIG. 3A. For purposes of this illustration it will be assumed that the user or participant has selected The Ohio State University® as his or her team of choice. As indicated at block 40 in FIG. 3A, note that the user or participant may create an account before or after any particular signing day.

For ease of description and understanding, note that the procedural blocks shown in FIGS. 3A-3B are shown with an associated hypothetical day to show an exemplary progression of the process for playing the game. On the first day (identified as February 2013) at block 40 in FIG. 3A, note that the user or participant's point total or tally stands at zero. The game in the hypothetical example proceeds to block 42 (FIG. 3A) wherein the user or participant updates the number of scholarships that the user or participant believes that his or her selected college or university will award on the upcoming signing day (i.e., the signing day in 2014 in the illustration shown). If it is a new account and the user or participant has not selected the number of scholarships they believe that the college or university will award, the system 10 may assign a default number of scholarships, such as twenty-five scholarships in the illustration being described. In the illustration, the user or participant changes or updates their prediction of the number of scholarships that The Ohio State University® will award to eighteen (18). Note that at this point, the server 12 calculates the total points as associated with this activity as zero (0) because the predetermined scholarship bonus points or predetermined scholarship penalty are not awarded or deducted, respectively, until the upcoming signing day.

Again, at block 40 in FIG. 3A, the user or participant populates or fills his or her recruiting list or roster with the selected recruits who the user or participant believes will commit to that user or participant's college or university (The Ohio State University®, in the example). The recruit names are imported from other websites, such as 247sports.com and stored in the database, assembled by the recruiting staff or entered by the participant. In the hypothetical example presented, the user or participant fills his or her recruiting list or roster using the website 16 with fifteen recruits who the user or participant believes will sign with The Ohio State University® on the next or upcoming signing day, in this case signing day in 2014. It should be understood that the recruits that the user or participant assigns to his recruit list may not have committed to any college or university or, alternatively, may have already committed to a college or university, including the one selected by the user or participant. If one or more recruits has already committed to a college or university, a user or participant may still accumulate points for selecting that committed recruit.

Throughout play, the server 12 will provisionally accumulate points based upon the user or participant's pick(s). In the hypothetical example, it is assumed that the user or participant has filled his or her recruiting list or roster with fifteen (15) recruits that he or she believes will sign with The Ohio State University® on 2014. In the example, assuming two out of the fifteen selected recruits have already verbally committed to The Ohio State University®, that earns the user or participant provisional predetermined correct pick awards. In the example, this would be four thousand provisional correct pick points instantly (two successfully selected recruits times two thousand points from the Table I above). At this point in the illustration, the user or participant's total points tally is maintained as calculated by the server 12 and stored in the memory storage device 12b stands at four thousand provisional points.

Assuming in the illustration that a few months into the game the user or participant removes two recruits (block 42 in FIG. 3A) from his or her recruiting list or roster and replaces them with two different recruits. The server 12 recalculates the total points tally using the controller 12a and triggers the predetermined recruit removal penalty described earlier. In the example, this means an eighty point deduction from the user or participant's total point tally. In the illustration and as mentioned earlier herein relative to the point Table I, note that the game tallies or assigns a point penalty for a period equal to the number of weeks that a recruit was placed on the recruiting list or roster and then removed by the user or participant. In the hypothetical example, the two recruits that were removed by the user or participant were on the recruiting list or roster for eight weeks or two months into the game which triggered a forty point penalty for each recruit removed from the recruiting list or roster (i.e., minus five points times eight weeks (−5×8) for recruit one and minus five (−5) times eight weeks (−5×8) for recruit two). Note at this point, that the controller 12a calculates the user or participant's total point tally in the illustration at forty five hundred and twenty points ((4,000−80) plus 600). Note also that in the illustration the extra or bonus six hundred points came from the two previously-selected recruits who, in the illustration, committed to the user or participant's college or university. Therefore, these are deemed to be correct picks, so the predetermined commitment bonus award is awarded. In the example, the predetermined commitment bonus award is five points per day, per pick, for sixty days. In other words, it should be appreciated that once a recruit commits to a college or university, the point system in accordance with one embodiment of the invention, provisionally awards not only the predetermined correct pick award and a provisional award of the predetermined commitment bonus award for the correct pick, which includes a daily tally of points for each day that that recruit was on the user or participant's recruiting list or roster. This means that the longer a correct recruit pick is on the user or participant's recruiting list or roster, the more points will be awarded or accumulated. Stated another way, the earlier the user or participant selects a recruit on his or her recruiting list or roster, the more points the user or participant may be awarded. This is why, as mentioned earlier herein, there is motivation for a user or participant who is not competing in a closed league to begin play as close to a starting signing day as possible and to populate his or her recruiting list or roster as soon as possible because of the points awarded. Although the points as described herein were awarded on a per day basis, it should be understood that all points could be awarded on other bases, such as a lump-sum or fixed award, a per week, per month, per hour basis or other variable basis.

Continuing with the illustration in FIG. 3A, note at block 44, that approximately three months or ninety days into the playing of the game, one of the user or participant's recruits verbally commits to that user or participant's selected college or university, The Ohio State University® in the illustration being described. This earns the user or participant the predetermined correct pick award and predetermined commitment bonus award. In the example, this is twenty four hundred and twenty points, which is calculated as follows: two thousand points for the correct pick, plus five points per day that the user or participant had the recruit on his or her recruiting list or roster. Note that because this is a verbal or “soft” commitment by the recruit, these points are provisional until the next or upcoming signing day because, for example, if the recruit de-commits, then those points are taken away. In the illustration, the controller 12a of server 12 calculates the user or participant's total point tally as sixty-eight hundred and sixty provisional points, which is the previous point total of forty five hundred and twenty points in the illustration being described plus the additional twenty four hundred. In the illustration being described, the calculation is two thousand points for the correct pick plus five points per day that the user or participant had the recruit on his or her recruiting list or roster, or five times eighty-four days. Continuing with the hypothetical example, note at block 46 (FIG. 3A) that it is assumed that a recruit on the user participant's recruiting list or roster commits to a college or university that is different from the college or university selected by the user or participant. The software on server 12 assesses the predetermined incorrect pick penalty. In this example, the software calculates a point deduction or penalty of minus five hundred and eighty five points which is calculated as follows: five hundred points for the predetermined incorrect pick penalty, plus the predetermined recruit removal penalty. In the example, this is minus five point penalty for each day that the user or participant had that recruit on his or her recruiting list or roster after the user or participant removes that recruit from his or her recruiting list or roster. Note that the user or participant's total point tally in the illustration now stands at sixty two hundred and eighty provisional points (the previous sixty eight hundred and sixty total provisional points less the five hundred and eighty points calculated herein).

The routine or game proceeds to block 48 (FIG. 3B) where, one hundred and sixty days into the game (i.e., August 2013 in the illustration being described), four of the user or participant's selected recruits verbally commit to his or her selected college or university. In the illustration, the recruits verbally commit to The Ohio State University®. This provisionally earns the user or participant the predetermined correct pick award and predetermined commitment bonus award. In the example, this is calculated as eleven thousand three hundred and sixty points (two thousand points per correct pick, plus five points per day (five times one hundred and sixty days) that the user or participant had each of the recruits on his or her recruiting list or roster. The user or participant's total points tally is calculated by the software of server 12 as nineteen thousand four hundred provisional points. This number is stored in the memory or storage device 12b in a manner conventionally known.

Continuing at block 50 in FIG. 3B, note that a hypothetical transaction wherein the user or participant modifies the number of scholarships he or she believes his or her selected college or university will award. In the example, this is the second time the user or participant changed his forecast, so a point penalty of the predetermined scholarship penalty is assessed for changing his forecast. In the illustration being described, twenty five points would be deducted by the software on server 12 from the user or participant's total point tally. In the example, the user or participant is entitled to change his selection once without penalty.

Continuing further with the illustrative example at block 52 in FIG. 3B, note that the game is now progressed to the end, which in the example is the signing day in February 2014. At this point, the software on the server 12 calculates the total point tally for all users or participants who played the game. In the illustration, on signing day 2014, the user or participant already had seven picks who verbally (but not formally) committed to The Ohio State University® before the signing date. As mentioned earlier, the server 12 had provisionally awarded points associated with those verbal commitments, but did not permanently assign the predetermined correct pick award and predetermined commitment bonus award for the recruits to the user or participant. Assuming in the hypothetical that only five of the seven recruits actually send in or sign their scholarship acceptance letters or national commitment letters, the server 12 and the software calculates any provisional points associated with the five recruits who actually did sign scholarship acceptance letters for the user or participant's college or university and turns those “provisional” points into official points for those five recruits. In the illustrative example, this means that the points associated with those five recruits is nineteen thousand one hundred points which is calculated as follows: two thousand points per recruit plus five points per day that the recruit was on the user or participant's recruiting list or roster.

As further illustrated at block 52 in FIG. 3B, note that in the illustration, one of the user or participant's seven recruits who had earned the user or participant the provisional award of the predetermined correct pick award and predetermined commitment bonus award for the recruits, surprises the public and signs with a different college or university. The server 12 then calculates an assessment of penalties by causing the user or participant to lose all of the provisional points he or she had accumulated for that recruit and is assessed the predetermined incorrect pick penalty mentioned earlier. This means a minus six hundred and twenty point penalty (minus five hundred points for each recruit on the user or participant's recruit list who does not commit to the user or participant's college or university and an additional minus five points per week that the recruit was on the user or participant's recruiting list or roster).

Finally, in the example shown in FIG. 3B (block 52), note that a seventh recruit who earned the user or participant provisional points is still “committed” to the user or participant's selected college or university, but fails to send in any scholarship acceptance letter or commitment letter on or before the 2014 signing day. The server 12 and software then recalculate the points that the user or participant is awarded as mentioned earlier relative to the unsigned penalty. In the example, the server 12 recalculates the award of points as one thousand points for a correct pick of a recruit, plus five points per day that the recruit was on the user or participant's recruiting list or roster for a total of twenty eight hundred and twenty points.

In the embodiment being described, other points may be awarded by system 10 for other activities, such as the user or participant correctly guessing the number of scholarships awarded on signing day 2014, then the system awards the predetermined scholarship bonus mentioned earlier. In the illustration being described, the user or participant guessed that his or her college or university would award eighteen scholarships on signing day 2014, so the user or participant is awarded fifteen hundred (1500) points. If instead, the user or participant's college or university awarded a different number, such as nineteen scholarships, then the predetermined scholarship penalty (e.g., twenty five points) is assessed. In one embodiment, there is no penalty for such an incorrect pick and the user or participant's total point tally remains unchanged.

Continuing with the illustration being described in block 52 in FIG. 3B, in addition to the seven recruits mentioned earlier on the user or participant's recruiting list or roster who verbally committed to The Ohio State University before signing day 2014, the user or participant had selected four recruits who actually did commit to the user or participant's selected college or university on the signing day 2014. That earns the user or participant fifteen thousand two hundred and eighty points (two thousand points per pick plus five points per recruit per day that the user or participant had those recruits on his or her recruiting list or roster).

Continuing on with the illustration, the user or participant now has seven recruits left on his or her recruiting list or roster and assuming those seven recruits sign with other colleges or universities other than the user or participant's college or university or they did not sign or commit to any college or university on signing day 2014, the server 12 and software trigger a minus seven hundred and sixty point penalty per recruit (minus five hundred points for each recruit and minus five points per week the user or participant had that recruit on his or her recruiting list or roster) for a total of six thousand eight hundred and twenty total points.

It should be understood that the above scoring demonstration assumes that the user or participant made all of his or her recruit picks on the same day which was the first day after the 2013 signing day. It is also assumed in the above illustration that the user or participant did not change his or her picks outside of the adjustment mentioned earlier herein where the user or participant removed one recruit but did not add a new recruit to that slot. It should be understood, however, that the user or participant may add recruits and remove them at any time during play or prior to the next signing day, subject to the point calculations referred to herein. The recruits can also be removed or added to the roster at different times, but there is motivation to add recruits early in view of the point awards.

Referring now to FIGS. 4A-4F, another illustrative example of the play of the recruiting game for a plurality of users or participants, process and system and the associated accumulation of points will now be described relative to FIGS. 4A-4F. In this example, multiple players are shown competing against each other. The game starts at block 54 (FIG. 4A) wherein play starts the day after signing day which is also known as day 1. For ease of illustration and play of the game and accumulation of points it will be assumed that two participants, a first user (User 1) and a second user (User 2), are playing the game. At block 56, the first user creates his account on the day after signing day or day 1 in the manner described earlier herein, and the second user does likewise at block 58. Of course, if a user already has an account, this step can be skipped. Again, for ease of illustration and comparison, it should be understood that the first and second user's play can be of any order and the order described herein is merely illustrative. Users or participants do not have to begin play on the same day, but in this example, they do for ease of illustration.

At block 60, the first user selects a college or university that he or she would like to make its recruit picks and compete with. In the illustrative example, the user may join a league such as a hypothetical “GBL League” which the user may create using the website 16 through the use of the web browser 18. Alternatively, the system 10 may present the user with the option of joining an existing league stored in database 14. In the illustration being described, the GBL League comprises a league of people, such as a participant's friends, who have also selected the same college or university and will be competing against each other, as well as competing against all other participants who have selected the same college or university. In other words, it should be understood that groups of participants may be organized and arranged using the system 10 by setting up leagues of persons who have selected the same college or university and the system 10 tracks all users or participants who have selected the same college or university, and tallies points for both the league, division and game and all users or participants in the league. In this regard, a league does not necessarily mean “Big Ten”, but could mean a group of fans and could consist of as little as two participants. If there are ten players in the league and each player has ten points, then the tally for the league is one thousand points.

The illustration continues at block 62 (FIG. 4B) wherein the second user selects a college or university for whom they would like to make picks. For ease of illustration and to illustrate the competition between the first and second users, it is assumed that the second user also selects the same college or university as the first user and also joins the GBL League to compete against the first user as well as the other users or participants who are in the GBL League. Like the first user, the second user will also compete against all other users or participants who selected the same college or university. In one illustrative embodiment, the college or university may be set up in divisions, such as The Ohio State University division, wherein all users or participants have selected The Ohio State University as their college or university to compete with. A division includes all the game's players who are competing with the same team (i.e., Ohio State) so players can compete with friends in a league and Ohio State fans in their division.

Continuing with the illustration at block 64, note that the first user chooses the total number of scholarships expected for the selected college or university and the second user does likewise (block 66). Thereafter, the first user picks recruits expected to fill scholarship slots by position as described earlier herein and adds them to his or her roster (block 68). The recruit names can be entered by hand or they can be stored in the database. The illustrative game continues at block 70 (FIG. 4C) where the second user picks the recruits expected to fill scholarship slots by position and adds them to his or her roster. At block 72 in the illustration, the first user modifies his or her roster multiple times throughout the year and note that for comparison, the second user does not modify his or her roster (block 74) in the illustration.

At block 76, play ends on signing day of year two and scores are tallied. In this regard, note that the total duration of game play is approximately 364 days, but it should be understood that this duration of play may be increased or decreased to a predetermined number of days if desired. Also, intermediate (i.e., during the course of play) awards for current total point standing may be granted.

The remainder of the illustrative example shown in FIGS. 4D-4F is to illustrate various scenarios of point accumulation. It should be understood that this is an example only and of course the accumulation of points will vary based on the user or participant's picks. For example, in FIG. 4D at block 78, a user had ten correct picks (i.e., recruits who have verbally committed) and therefore is provisionally-granted the number of points assigned for each correct pick. In the illustration being described, the predetermined correct pick points and predetermined commitment bonus points are awarded for each correct pick. In this example, the first user would get 20,000 points (2,000×10) plus 5 points per day that he or she had that recruit on his or her recruiting list or roster. In the illustration it will be assumed that the first user accumulated 28,000 total points. Note that the first user did not have all of his or her correct picks on his or her recruiting list or roster the first day in the illustration being described and this will affect the point total.

By comparison, note at block 80 that the second user had five correct picks and the predetermined correct pick points and predetermined commitment bonus points are awarded. Thus, 2000 points for each correct pick and plus 5 points per day that he or she had that selected recruit on his or her recruiting list or roster for a total of 19,100 points in the illustration. Note that the second user had all of his or her picks on his or her recruiting list or roster and did not change those picks throughout the playing of the game during the year.

Further point tallies are shown at block 82 in FIG. 4D wherein the first user had 15 incorrect picks and receives the predetermined incorrect pick penalty and, therefore, loses 500 points in this example for each incorrect pick and is also penalized a predetermined number of points per day (minus 5 points per day in the illustration) that he or she had the recruit on his or her recruiting list or roster for a total point subtraction of 13,500 points. At block 84, the point deduction for the second user is tallied because it is assumed that the second user had seven incorrect picks and loses 500 points for each incorrect pick (3,500 points) and also loses an additional 5 points per day (minus 5 points per day) that he or she had the recruit on his or her recruiting list or roster (total point deduction of minus 5,320 points).

Continuing to FIG. 4E, further assumptions of play in the illustrative embodiment show that the first user did not correctly guess the number of scholarships that his or her selected college or university would award (block 86 in FIG. 4E), so the player does not receive the predetermined scholarship bonus, which is 1,500 points in the example. There is no penalty for getting the scholarship guess wrong, but there is a bonus for getting it right. In contrast, the second user did correctly guess (block 88 in FIG. 4E) the total number of scholarships that the selected college or university would award. Accordingly, the second user receives the predetermined scholarship award of points. In this example, the second user earns a 1,500 point bonus in the illustration at block 88 in FIG. 4E.

At block 90, note that the second user had a “soft commitment,” which, as mentioned earlier, is a recruit who verbally committed to a college or university, but did not sign an actual letter of commitment on or before the signing day. Accordingly, while the second user does not obtain a full award of points for correctly picking the recruit, a provisional award of the predetermined commitment bonus is given by the system 10. In the illustration being described, the soft commitment bonus is 1,000 points per recruit.

The illustrative game play proceeds to block 92 when, ten weeks into the game (which commences on the day after a signing day), the first user removed a total of ten recruits from his or her recruiting list or roster and is assessed the predetermined incorrect pick penalty. Here, a total penalty of minus 500 points, which is a removal penalty of minus 5 points per week, per recruit. Of course, in the illustration, it is assumed that the first user had removed the ten recruits from his or her recruiting list or roster for a period of ten weeks prior to the upcoming signing day. Note in comparison at block 94 in FIG. 4F, that the first user did not remove any recruits from his or her recruiting list or roster. It can be advantageous if the user or participant has correctly identified a recruit because points are not only awarded for the correct identification of the recruit but also bonus points are given for the number of points awarded per day that the user or participant had the recruit on his or her recruiting list or roster. Again, however, note that a minus five points per week penalty is assessed for each week that the user or participant had the incorrect recruit on his or her recruiting list or roster.

Referring back to the illustration at block 94, note that the second user did not remove any of the recruits from his or her recruiting list or roster, so no player removal penalties are assessed as described earlier herein relative to block 84 (FIG. 4D).

Referring back to the illustration at block 96 in FIG. 3F, note that it is assumed that the game proceeds to signing day and the software of the server 12 accumulates the total points for all users or participants in the league and all users or participants who have selected the same college or university to compete with. In the illustration shown in FIGS. 4A-4F, it is assumed that the second user beats the first user (block 96 in FIG. 4F) because the second user ends the game play with 18,100 total points (19,100−5320+1500+2820) and the first user ends game play with 14,000 total points (28,000−13,500−500).

In the illustrative example, it is assumed that the second user has the highest score in the GBL League (block 98) and wins the GBL League title. Not to be disappointed in the hypothetical example, the first user has the second highest score in the league. The system 10 may then accumulate and rank all users or participants who have selected the same college or university. In the illustration, the second user was ranked 330^{th} (block 100 in FIG. 4F) among all players in the GBL League, and the first user was ranked 475^{th} because the first user had the 475^{th} highest score.

### Additional Considerations and Advantages

Advantageously, the system 10 and process and game provide a process, system 10 and game whereby the user or participant is provided an online, skill-based, multi-player game that challenges users to correctly identify recruits and predict which ones will accept football scholarships at specific colleges or universities. Other advantages include:
An online, skill-based, multi-user or participant game that challenges users or participants to correctly identify high school football recruits and predict which ones will accept football scholarships at specific American colleges or universities.
An online game that challenges users to predict the number of football scholarships a particular American college or university will award in a given year.
A recruiting game that lets users set up “watch lists” to pull in the latest news and information on sought-after high school football recruits with all work being done through the established network database, such as 247Sports. Watch lists allow users to follow specific recruits they are targeting and considering adding to their team. Players can view their watch list at a glance to see news updates on a large number of recruits quickly and easily.
An online recruiting game that lets users or participants compete in small “leagues” against their family and friends, or in “divisions” against a national pool of fans of a particular university.
A sophisticated scoring system that awards points and accesses penalties based on accuracy of football recruiting picks based on how early the prediction is made.
An interesting source of data on recruiting predictions. Extrapolations from recruit trends will allow the users or participants to make and publicize recruiting predictions based on opinions within the game. Databases within the game present information such as the percentage of players who think a recruit will go to Ohio State.
A system and method that provides an interactive recruiting competition among a plurality of remote participants.
A recruiting game that utilizes actual information about actual recruits and colleges or universities.
A recruiting scoring system and method that awards points and assesses penalties based on the accuracy of the recruiting picks.
A recruiting system and method competition that awards points and assesses penalties based upon how early a recruit's selection of a college or university is made.
A system and method that provides a source of data on recruiting predictions.
An interactive competitive recruiting game that challenges users to not only identify recruits that will be recruited, but also predict which ones will accept scholarships at the colleges or universities.
A system and method that allows participants to compete in small leagues or divisions against themselves or against a national pool of fans of a particular college or university.

It should be understood that the game system 10 and procedure is performed by the software and server 12 executing computer instructions that are resident in the memory storage device 12b illustrated in FIG. 1. The system 10, as mentioned earlier, provides the user or participant with a website 16 and various web pages 16a or graphical user interfaces. The programming of these web pages 16a or graphical user interfaces and website 16 are merely illustrative and the following Table II provides a summary listing of the one or more pages that may be used in one embodiment of the invention. Again, it should be understood that the website 16 may be presented for use by the user or participant using the smart phone 20, computer 22, tablet 24 or any other smart device. The user or participant may also be presented with a mobile application (not shown) which enables the user or participant to play the game from a mobile or smart device. The Table II is merely illustrative of the web pages that may be presented to the user or participant at the website 16 and that are resident on the server 12 for access and use to play the game:

TABLE II

| Pages | Description |
|---|---|
| Public landing page | A page that advertises Fantasy Recruiting and gives |
| | potential users or participants a place to sign up. |
| Dashboard | A landing page users or participants see when logging |
| | into their accounts. It provides a number of stats, links |
| | and scoring information. |
| League Directory | A page where new or existing users or participants can |
| | join or create a league. |
| Create your league | A page where users or participants can create a |
| | league. |
| My Team Page | The main page for the game. This is where users or |
| | participants see the recruits on their roster, remove |
| | existing recruits, view correct/incorrect picks and |
| | access links to add players to specific positions. |
| My League Page | A landing page where users or participants can see |
| | recruiting news, league activity, league messages and |
| | league forum posts |
| Recruiting Targets | A page where users or participants can add recruits to |
| | their rosters. |
| Watchlist/Recruits Page | An in-depth recruiting watch list page where users or |
| | participants can see a customized list of recruits they're |
| | considering adding to their roster. This page will borrow |
| | most of its information from Twitter and 247sports' |
| | recruiting database (i.e.: |
| | http://ohiostate.247sports.com/Season/2013- |
| | Football/Targets) |
| Standings Page | A page where users or participants can go to see how |
| | they and their opponents are doing (this includes users |
| | or participants in their league, their division and |
| | nationally). |
| Scoreboard Page | A page where users or participants can go to see all |
| | the points they've won/lost as well as all the possible |
| | points they can get based on who's currently on their |
| | roster. |
| Message Board | A page where users or participants can post forum |
| | threads for one another. This page will show the titles |
| | of all the threads. |
| Message Board Thread | A page that shows the full text of a forum thread, all the |
| | responses and a place where users or participants |
| | themselves can respond. |
| League Settings | A page where users or participants can view (or edit) |
| | league settings, including the number of users or |
| | participants eligible for the league and whether the |
| | league is public or private. |
| Individual Settings | A page where users or participants can update their |
| | settings including whether their profile/info is public or |
| | private, their email address and password and opt-out |
| | of all emails from Fantasy Recruiting. |
| Email League (Popup) | A pop-up box where users or participants can email |
| | their other league members. |
| League Members | A page that lists all the league members and allows |
| | admins to message members, invite new members and |
| | delete existing members. |
| Scoring Rules/How to Play | A page that explains how to play and shows all the |
| | scoring rules for the game. This page will be editable |
| | by the admins. |
| Delete Account | A page that allows users or participants to cancel their |
| | accounts. |
| Individual History Page | A page that shows a user or participant their scores |
| | from the previous year (if applicable) |
| League History Page | A page that shows a user or participant league |
| | information from the previous year (i.e. last year's |
| | winners, points awarded, messages, forum posts, etc.) |
| Admin Sign-on Page | A page where admins can log in to the admin section of |
| | the site |
| Admin Landing Page | A page where admins can take a number of actions |
| | and access links to other portions of the site |
| Admin Commitment/De- | A page where admins can set recruits as committed (or |
| commitment Page | un-committed), potentially over-riding what appears in |
| | 247sports' database |
| Admin Article Creation/Edit | A page where admins can create articles that will |
| | appear on the fantasy recruiting public landing page |
| Admin Article List | A page where admins can see all the articles that area |
| | on the site. From here, they can click a link to create |
| | new articles or edit existing articles |
| Contact Us | A public page that includes contact information. This |
| | page can be edited by admins. |

While the system, apparatus and method herein described constitute preferred embodiments of this invention, it is to be understood that the invention is not limited to this precise system, apparatus and method, and that changes may be made therein without departing from the scope of the invention which is defined in the appended claims.

What is claimed is:

1. An interactive recruiting game system for use by a plurality of participants; comprising:
a server having a controller, storage and software for storing and calculating scores;
a recruit game resident on said server for enabling each of said plurality of participants to add at least one recruit who each of said plurality of participants forecasts will accept a scholarship to a predetermined college or university selected by each of said plurality of participants to each of said plurality of participants' recruit roster or list; and
a database for storing data during use of said recruit game;
wherein said server generates a score for each of said plurality of participants based on each of said plurality of participants' forecasts and the actual decisions of said at least one recruit;
software for storing and calculating scores.

2. The interactive recruiting game system as recited in claim 1 wherein said scholarship is an athletic scholarship.

3. The interactive recruiting game system as recited in claim 2 wherein said athletic scholarship is a football scholarship to a college or university.

4. The interactive recruiting game system as recited in claim 1 wherein said recruit game challenges each of said plurality of participants to predict a total number of scholarships that a college or university will award for a sport in a given year.

5. The interactive recruiting game system as recited in claim 1 wherein recruit game is adapted to permit each of said plurality of participants to select at least one college or university and said recruit game groups said plurality of participants into at least one category or league of participants who have selected the same college or university.

6. The interactive recruiting game system as recited in claim 1 wherein said recruit game comprises a scoring system that generates a score or points based upon at least one of the following rules:
a correctly picked recruit who, after being selected by a participant, officially commits to said participant's selected college or university;
a correctly picked recruit who, after being selected by a participant, unofficially commits to said participant's selected college or university;
an incorrectly picked recruit who, after being selected by a participant, does not commit to said participant's selected college or university;
a correct scholarship forecast regarding a number of scholarships to be awarded by said college or university;
a time period that a correctly picked recruit was on a participant's roster or recruit list of recruits;
a time period that an incorrectly picked recruit was on a participant's roster or recruit list of recruits; or
a removal of a recruit from a participant's roster or recruit list.

7. The interactive recruiting game system as recited in claim 6 wherein said scoring system generates said score or points based upon a plurality of said rules.

8. The interactive recruiting game system as recited in claim 6 wherein said scoring system generates said score or points based upon all of said rules.

9. The interactive recruiting game system as recited in claim 6 wherein said time period that a correctly picked recruit was on a participant's roster or recruit list of recruits is based on either days or weeks.

10. The interactive recruiting game system as recited in claim 6, wherein said time period that an incorrectly picked recruit was on a participant's roster or recruit list of recruits is based on either days or weeks.

11. The interactive recruiting game system as recited in claim 1, wherein said system further comprises:
a website adapted to present a plurality of web pages for playing said recruit game over the Internet.

12. The interactive recruiting game system as recited in claim 11, wherein said server is adapted to permit said plurality of participants to access and use said website using at least one of a smartphone, a tablet or a computer.

13. The interactive recruiting game system as recited in claim 1 wherein said recruit game is adapted to permit each of said plurality of participants to select a plurality of recruits for each of said plurality of participants' selected college or university.

14. The interactive recruiting game system as recited in claim 1 wherein said recruit game awards or penalizes any participant who correctly picks said recruit or incorrectly picks said recruit, respectively.

15. The interactive recruiting game system as recited in claim 14 wherein said award is a fixed number of points.

16. The interactive recruiting game system as recited in claim 14 wherein said award includes a variable number of points based upon a time period that said recruit was on a participant's recruit roster or list.

17. The interactive recruiting game system as recited in claim 14 wherein said award includes a variable number of points based upon a time period that said recruit was on a participant's recruit roster or list.

18. The interactive recruiting game system as recited in claim 1 wherein said score is a total score that is tabulated by said server on a signing day after a participant begins play of said recruit game.

19. A method of remotely interfacing with at least one player in a rule-based recruiting game over a communication medium operatively connected to one or more communication devices each being adapted to input and output data required by said rule-based recruiting game; said method comprising the steps of:
enabling at least one participant to use at least one of said one or more communication devises to add at least one recruit who said at least one participant forecasts will accept a scholarship to a predetermined college or university selected by said at least one participant to said at least one participant's recruit roster or list; and
generating a score for said at least one participant by applying rules of said rule-based recruiting game based upon each of said at least one participant's forecasts and the actual decisions of said recruits.

20. The method as recited in claim 19 wherein said scholarship is an athletic scholarship.

21. The method as recited in claim 20 wherein said athletic scholarship is a football scholarship to a college or university.

22. The method as recited in claim 19 wherein said method further comprises the step of:
increasing or decreasing said score based upon at least one participant's accuracy of a forecast of a total number of scholarships that a college or university will award for a sport in a given year.

23. The method as recited in claim 19 wherein said method further comprises the step of:
enabling each of said at least one participants to select at least one college or university;
grouping each of said at least one participants into at least one category or league of participants who have selected the same college or university.

24. The method as recited in claim 19 wherein said generating step further comprises the step of:
generating said score based upon at least one of the following rules:
a correctly picked recruit who, after being selected by said at least one participant, officially commits to said at least one participant's selected college or university;
a correctly picked recruit who, after being selected by said at least one participant, unofficially commits to said at least one participant's selected college or university;
an incorrectly picked recruit who, after being selected by said at least one participant, does not commit to said at least one participant's selected college or university;
a correct scholarship forecast regarding a number of scholarships to be awarded by said college or university;
a time period that a correctly picked recruit was on said at least one participant's roster or recruit list of recruits;
a time period that a incorrectly picked recruit was on said at least one participant's roster or recruit list of recruits; or
a removal of a recruit from said at least one participant's roster or recruit list.

25. The method as recited in claim 24 wherein said generating step further comprises the step of:
generating said score or points based upon a plurality of said rules.

26. The method as recited in claim 24 wherein said generating step further comprises the step of:
generating said score or points based upon all of said rules.

27. The method as recited in claim 24 wherein method further comprises the step of:
generating said score using said time period that a correctly picked recruit was on said at least one participant's roster or recruit list of recruits and wherein said time period is based on either days or weeks.

28. The method as recited in claim 24 wherein method further comprises the step of:
generating said score using said time period that an incorrectly picked recruit was on said at least one participant's roster or recruit list of recruits and wherein said time period is based on either days or weeks.

29. The method as recited in claim 19 wherein said method further comprises:
providing a website adapted to present a plurality of web pages for playing said rule-based recruiting game over the Internet.

30. The method as recited in claim 19 wherein said one or more communication devices is at least one of a smartphone, a tablet or a computer.

31. The method as recited in claim 19 wherein said method further comprises the step of:
permitting each of said at least one participant to select a plurality of recruits for said at least one participant's selected college or university.

32. The method as recited in claim 19 wherein said generating step further comprises the step of:
recalculating the score by adding award points or deducting penalty points from said at least one participant's score for any participant who correctly picks said recruit or incorrectly picks said recruit, respectively.

33. The method as recited in claim 32 wherein said award is a fixed number of points.

34. The method as recited in claim 32 wherein said award includes a variable number of points based upon a time period that said recruit was on said at least one participant's recruit roster or list.

35. The method as recited in claim 19 wherein said generating step ends on a signing day after said at least one participant begins play of rule-based recruiting game.

36. The method as recited in claim 19 wherein said method comprises the step of:
awarding prizes periodically to at least one of said at least one participant who has the highest score at any given time during play of rule-based recruiting game.

37. A method of playing a multiplayer recruit game which corresponds to an actual sporting event, said method comprising the steps of:
providing, to each of a plurality of participants, at least one web page for forecasting what recruits will accept a scholarship to a predetermined college or university selected by each of said plurality of participants and to adding the forecast recruits to each of said plurality of participants' recruit roster or list;
receiving from each of said plurality of participants, prior to a signing day, forecast decisions regarding the acceptance by one or more of said recruits of a scholarship to said predetermined college or university;
enabling each of said plurality of participants to modify said forecast decisions during play of said multiplayer recruit game;
obtaining at the conclusion of said multiplayer recruit game, information regarding actual selections by said recruits of their acceptance or non-acceptance of said scholarship to said predetermined college or university; and
generating a score for each of said plurality of participants based upon a correlation between said forecast decisions received from each of said plurality of participants and the actual commitments by each of said recruits.

38. The method as recited in claim 37 wherein said scholarship is an athletic scholarship.

39. The method as recited in claim 38 wherein said athletic scholarship is a football scholarship to a college or university.

40. The method as recited in claim 37 wherein said method further comprises the step of:
increasing or decreasing said score based upon a participant's accuracy of a forecast of a total number of scholarships that a college or university will award for a sport in a given year.

41. The method as recited in claim 37 wherein said method further comprises the step of:
enabling each of said plurality of participants to select at least one college or university;
grouping each of said plurality of participants into at least one category or league of participants who have selected the same college or university.

42. The method as recited in claim 37 wherein said generating step further comprises the step of:
generating said score based upon at least one of the following rules:
a correctly picked recruit who, after being selected by a participant, officially commits to said participant's selected college or university;
a correctly picked recruit who, after being selected by a participant, unofficially commits to said participant's selected college or university;
an incorrectly picked recruit who, after being selected by a participant, does not commit to said participant's selected college or university;
a correct scholarship forecast regarding a number of scholarships to be awarded by said college or university;
a time period that a correctly picked recruit was on a participant's roster or recruit list of recruits;
a time period that a incorrectly picked recruit was on a participant's roster or recruit list of recruits; or
a removal of a recruit from a participant's roster or recruit list.

43. The method as recited in claim 42 wherein said generating step further comprises the step of:
generating said score or points based upon a plurality of said rules.

44. The method as recited in claim 42 wherein said generating step further comprises the step of:
generating said score or points based upon all of said rules.

45. The method as recited in claim 42 wherein method further comprises the step of:
generating said score using said time period that a correctly picked recruit was on a participant's roster or recruit list of recruits and wherein said time period is based on either days or weeks.

46. The method as recited in claim 42 wherein method further comprises the step of:
generating said score using said time period that an incorrectly picked recruit was on a participant's roster or recruit list of recruits and wherein said time period is based on either days or weeks.

47. The method as recited in claim 37 wherein said method further comprises:
providing a website adapted to present a plurality of web pages for playing said multiplayer recruit game over the Internet.

48. The method as recited in claim 37 wherein one or more communication devices is at least one of a smartphone, a tablet or a computer.

49. The method as recited in claim 37 wherein said method further comprises the step of:
permitting each of said plurality of participants to select a plurality of recruits for each of said plurality of participants' selected college or university.

50. The method as recited in claim 37 wherein said generating step further comprises the step of:
recalculating said score by adding award points or deducting penalty points from each of said plurality of participants' score for any participant who correctly picks said recruit or incorrectly picks said recruit, respectively.

51. The method as recited in claim 50 wherein said award is a fixed number of points.

52. The method as recited in claim 50 wherein said award includes a variable number of points based upon a time period that said recruit was on each of said plurality of participants' recruit roster or list.

53. The method as recited in claim 37 wherein said generating step ends on a signing day after each of said plurality of participants begin play of said multiplayer recruit game.

54. The method as recited in claim 37 wherein said method comprises the step of:
awarding prizes periodically to at least one of said plurality of participants who has the highest score at any given time during play of said multiplayer recruit game.
